(19) United States
(12) Patent Application Publication
(10) Pub. No.: US 2013/0145249 A1
(43) Pub. Date: Jun. 6, 2013

(54) SMART ANNOTATION ANCHORING PROCESS

(71) Applicants: Ross Harper, Manchester (GB); Ed Nurse, Manchester (GB); Roy Howarth, Cheshire (GB)

(72) Inventors: Ross Harper, Manchester (GB); Ed Nurse, Manchester (GB); Roy Howarth, Cheshire (GB)

(73) Assignee: MYRIAD FRANCE, LE BOURGET-DU-LAC (FR)

(21) Appl. No.: 13/543,410

(22) Filed: Jul. 6, 2012

(30) Foreign Application Priority Data
Jul. 6, 2011 (FR) 11 56112

(51) Int. Cl. G06F 17/24

(52) U.S. Cl. CPC G06F 17/241
USPC 715/230

(57) ABSTRACT

The electronic device (12) comprises means for injecting into a document an annotation application (22) to extend the document. The annotation application (22) is suitable to be executed according to an extended document only in the context of execution of a document return management module (60) of a navigation application (56) on the source data and treated data of the document return management module (60) and by using the same functions as the document return management module (60) and that the document treated by the navigation application (56) comprises graphic elements, the annotation application (22) being suitable for anchoring an annotation (78) to a point of a graphic element of the document independently of the coordinates of the graphic element in the document.

The present invention concerns an electronic device.

More precisely, the invention concerns an electronic device of the type that contains a treatment unit, anchoring means, a navigation application that contains a module for managing the graphic interface of access to a network and a module for managing the return of the document defining a context of execution of the module for managing the return which context contains the source data and treated data of the module for managing the return of the document and an annotation suitable for returning and/or adding annotations to a document treated by the application of navigation so as to anchor a representation of the annotated document.

Such a device allows a user to add personalized annotations to a document, for example a Web document, a PDF file etc., and to visualize annotations added by another user to this document from a data processing device or a portable telephone.

An annotation is a graphic element associated with a document and contains a content that is not native to the document supplied by a user. Such annotations thus allow users to exchange information, suggestions, impressions etc. relative to a document via the document itself rather than, for example, via a messaging system.

These annotations take the form of, for example, a note, a link, or an image pointing toward an element of the document to which it refers.

Conventionally, an annotation application is implemented in the form of a “plug-in” of a navigation application that is of an extension depending on the application of navigation to the document. It then interacts with the navigation application and anchors annotations generated or returned on the representation of the document which the navigation application generates.

One such application is described, for example, in US 2011/0066957 A1.

In this document, an annotation application is an extension of the navigation application installed on the data processing device. The navigation application then brings about the anchoring of the tool link adapted to the creation and to the processing of annotations on the visualized document. The generated or returned annotations and the tool link are superposed by the extension to the representation of the document generated by the navigation application.

Such a process is not fully satisfactory. In fact, the application of annotation is a dependence of the application of navigation and, hence, to function it must be compatible with the application of navigation. A user of a second application of navigation thus cannot visualize annotations generated via a different first application of navigation or create annotations that can be visualized via another application of navigation without making use of an extension which must be specifically developed for the second application of navigation.

One object of the invention is therefore to obtain an annotation process the application use of which is adapted to all navigation applications.

In effect, the invention has for an object an electronic device of the above-indicated type, characterized in that it contains means of injection into the document of said application of annotation to extend the document, and the application of annotation is suitable to be executed from the extended document only in the context of execution of the module of management of the return of the document on the source data and treated data of the management of the return of the document and by using the same functions as the module of management of the return and in that the document treated by the application contains graphic elements, the application being suitable for anchoring an annotation to a point of a graphic element of the document regardless of the coordinates of the graphic element in the document.

The device of the invention can contain one or the other of the following characteristics by themselves or in any technically possible combination:

it contains means of teleloading from a dedicated application server:

the navigation application contains means of releasing the injection of the annotation application into the electronic device;

the navigation application contains means of creating scripted page markers that can be personalized, the means of injection of the annotation application containing the actuation of a scripted page marker;

the document is an HTML file, and

the modulus of management of the return of the application or applications of navigation contains means of generating the representation of the annotated document from DOM representations of the document.

The invention will be more readily understood by reading the following description which is provided only as an example and which refers to the attached drawings, in which

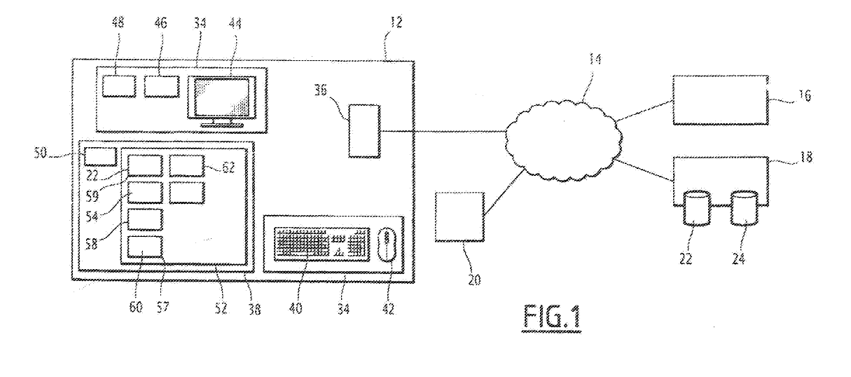

FIG. 1 is a schematic representation of an overall system comprising an electronic device suitable for carrying out the process of the invention;

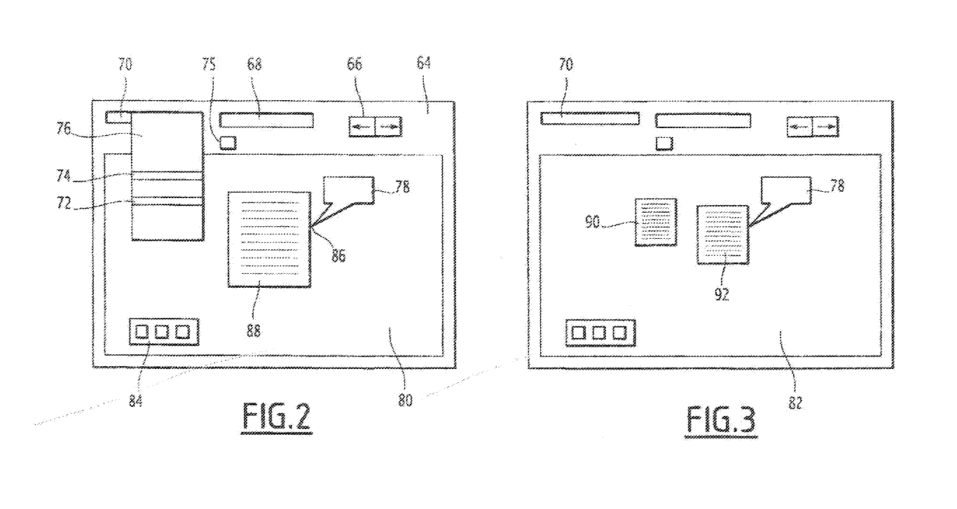

FIG. 2 is a schematic representation of a target representation of a Web document via an application of navigation executed by a device of the invention;

FIG. 3 is a schematic representation of a source representation of the same document as that shown in FIG. 2, and

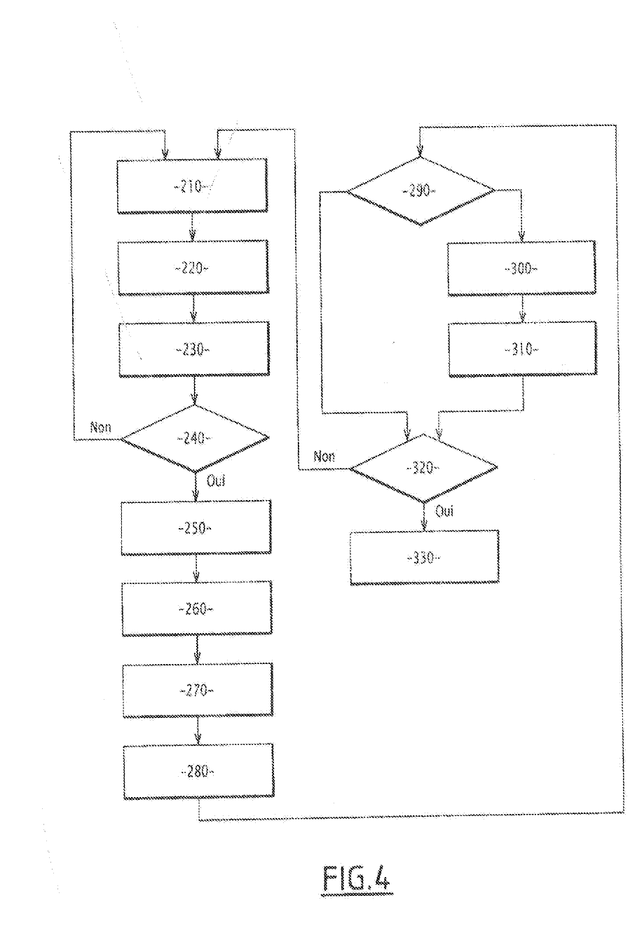

FIG. 4 is an organization chart of a process of the invention.

Overall system 10 has an electronic device 12 capable of interacting with a network 14 so as to establish communication with at least one Web server 16, a server 18 dedicated to the application of carrying out the process of the invention, and another data processing device 20.

In a known manner, Web server 16 is suitable for storing documents, for example HTML pages, of multimedia content etc. The server is also suitable for treating a request it receives and which comes from electronic device 12 or 20. In conventional manner, the treatment of the request by server 16 results in the server sending a document it contains to the destination of the device from which the request came.

Server 18 is suitable for storing an annotation application 22 and annotation data 24 generated by annotation application 22 during its functioning, as will be seen in the following

Electronic device 12 consists, for example, of a personal computer, a portable telephone or a touch-screen tablet. It contains means 32 for capturing information generated by a user, means 34 for visualization, means 36 for communication with another distant electronic device, and a central treatment unit 38 suitable for executing applications needed for the functioning of electronic device 12.

In a known manner, means of capture 32 contain a keyboard 40 from which the user can give instruction for executing the software, the functionalities of this software, add text to a document etc. Means of capture 32 also comprise means of interaction with information displayed on visualization means 34, for example a mouse 42.

Means of visualization 34 contain in a known manner a screen 44 and means of treating graphic information, for example a graphic processor 46 and an associated graphic memory 48.

Graphic processor 46 is suitable for treating graphic information stored in graphic memory 48 and anchoring this information or a representation thereof on screen 44.

Advantageously, means of capture 32 and means of visualization 34 can have a common form, for example in the case of a touch-screen.

Means of communication 36 comprise an interface network allowing data processing device 12 to communicate with the other devices of network 14.

Central treatment unit 38 comprises a processor 50 and one or more memories 52.

Processor 50 is suitable for carrying out applications contained in memory 52, particularly an exploitation system allowing conventional functioning of an electronic device.

Memory 50 contains different memory zones, allocated statically or dynamically, which contain applications intended to be carried out by data processing device 12.

Memory 50 thus contains at least one request-sending application 54, three modules of a navigation application 56, a memory zone 57 allocated to a module 60 of management of the application of navigation as will be shown in the following, and one memory zone 59 allocated to application 22 of carrying out process 23 of the invention.

The purpose of request-sending application 54 is to instruct data processing device 12 to send a request to the destination of a distant device via its communication means 36.

When request-sending application 54 is executed by device 12, a connection with the network is established via a communication protocol, for example the http protocol (Hyper-Text Transfer Protocol) or UMTS protocol (Universal Mobile Telecommunications System) in the case of a telephone, and a request, for example an http request, is sent to the said device through network 14.

As is known, when the distant device is a Web server and the request is an http request containing the URL address (Universal Resource Locator) of a resource stored on the distant device, for example a Web page, the Web server returns the requested resource to electronic device 12.

Request-sending application 54 is also suitable for sending requests to the destination of dedicated server 18. The reception of a request by dedicated server 18 initiates the sending of annotation application 22 itself to the destination of the data processing device 12, as will be seen in the following.

The purpose of navigation application 56 is to allow the user to access a content, for example a Web document, to visualize it on the means of visualization 34 and to interact with this content, particularly via a graphic interface 64 which contains application 56.

As is known, an application of navigation contains at least one module 58 of management of a graphic interface of access to a network, a module 60 of return management and a module 62 of extension management.

These modules correspond to the software subassemblies of the application of navigation 56 that implement the functions that compose them.

The purpose of module 58 of interface management is to guide the elements of graphic interface 64 of the application and to ensure the connection to the network to request and receive a Web page, in particular.

As is known, these elements can contain knobs 66 for scrolling between the visualized documents, a link for navigation and a link for the scrolling menu 70. The user then interacts with these elements via capture means 32.

The purpose of return-management module 60 is to guide all the functionalities associated with the treatment of the documents and to carry out the anchoring on the visualization means 34.

As is known, the purpose of this module 60 is to create a representation of the document, to add graphic elements to the visualized document, to carry out the multimedia content of the document, to execute the “scripts” that are present there and to interact with the actions of the user.

During the functioning of navigation application 56, the receipt of elements associated with a Web page that the user wants to consult initiates their treatment by central unit 38 and their being sent toward of return-management module 60. The latter then brings about the construction of a representation of the document which is then safeguarded in memory 46 of means of visualization 34 and then displayed on screen 44.

Module 60 of return management corresponds to the heart of the navigator and is based on the use of standard languages and technologies recommended by W3C (World Wide Web Consortium). These technologies contain, for example, the HTML, the CSS (Cascading Style Sheet) and the Javascript which is a language of manipulation of objects provided by an application such as navigation application 56.

In fact, the return-management modules of different navigation applications have common functionalities based on the utilization of these standards.

Thus, an application guided by the module of management of a navigation application is adaptable to different applications of navigation.

The purpose of module 62 of extension management is to guide the extensions that depend on application 56 and in particular to transmit to these extensions the information they need to be able to function.

As is known, these extensions or “plug-ins” make it possible to add to application of navigation 56 new functionalities without having to modify these. In particular, they make it possible for application of navigation 56 to take charge of non-standard files, for example the Flash.

As these extensions are dependent on navigation application 56 to be able to function, they are not transposable from a given navigation application to a different navigation application. The extension that implements a given functionality thus must be specifically adapted to the navigation application upon which it depends.

As is known, a Web document is constructed by use of a markup language, for example the Hypertext Markup Language or HTML. Other languages and technologies currently utilized for the construction of such a document are the Extensible Markup Language or XML, JavaScript, Cascading Style Sheet (CSS) etc.

The markup language allows a developer, a content creator etc, to construct a document by adding to it marked-up elements semantically. The markings are then treated by the module of return management which generates from them a logical representation of the document with which the application modules interact.

In a device of the invention, return-management module 60 implements the logical representations of the Document Object Model (DOM) type. A DOM representation of a document defines the logical structure of the document in arborescent form. Each node of the arborescence corrersponds to an element of the structured document, for example an image, a block of text, a link etc.

Each node contains nodes known as “threads” located on a low line in the arborescence. Each thread of this node corresponds to a logical portion of the document of granularity higher than this node, that is to say of greater detail.

Thus, the node of the first line of the DOM representation corresponds to the entire document, its threads correspond to logical principal portions of the document, their threads correspond to logical portions of these principal logical portions etc.

In the following, the data “treated” by module 60 correspond to the DOM representation of the document from which is created a representation anchored on the means of visualization 44. The data referred to as “sources” of module 60 correspond to the data—for example of code HTML—of the document needed by module 60 to create the DOM representation.

Navigation application 56 also contains several functionalities illustrated in FIG. 3.

As is known, one of these functionalities allows the user to capture in the navigator via a navigation link 68 the URL of a resource to which he wants to accede.

Application of navigation 56 is also suitable for allowing the user to generate page markers 72 that will allow him to accede rapidly to a given resource.

This functionality is guided by interface management module 58 and is, for example, implemented in the form of a dedicated knob 75 and tabs in a scrolling application menu 76.

As is known, when the user wants to create a page marker 72 associated with a specific resource, he will “click” with the mouse on knob 75 of the resource. Interface management module 58 orders the central treatment unit 38 to execute a command resulting in the creation of a page marker 72 which is then accessible via a tab in scrolling menu 76.

When the user wants to accede to a resource with which is associated a page marker 72, he clicks with the mouse on the corresponding tab in the scrolling menu 76. The navigator then executes a command resulting in a request being sent by the data processing device 12 to a distant server on which is stored the resource corresponding to page marker 72.

In the conventional manner, these page markers 72 can be replaced by “scripted” page markers 74.

The purpose of a scripted page marker 74 is to make it possible, besides gaining access to a distant resource, to execute a script, for example a Javascript, which is contained in the scripted page marker. Thus, a functionality richer than simple access to the resource can be associated with a page marker 72 via a scripted page marker 74 that replaces it in scrolling menu 76. As is known, these scripted page markers 74 allow the modification of the visualized document, the consultation of a search motor, the execution of a particular request etc.

Annotation application 22 can be used by electronic device 18 after having been “injected” into the document. The injection is performed in the following way: the scripted page marker creates a <script> element in the document by the bias of the standard Javascript function.document.createElement (‘script’), then assigns the source of this script to a Javascript file located on server 18 by modifying the src attribute of the <script> element created previously. Finally, the <script> element is added into the document by the bias of the standard JavaScript function document body.appendChild(s), where s is the previously created <script> element, the effect of which is to release the injection and then the execution of the Javascript file pointed out by s.

In data processing, by injection of an application to a document is indicated the addition of a code and of functions constituting the application to the document.

In practice, application 22 implements the code comprising functions and scripts in the HTML, CSS and Javascript languages as will be shown in the following.

During the injection of application 22 into the document these functions and these scripts are added to those that compose the document itself.

Application 22 thus effects an extension of the document.

The purpose of this annotation application 22 is to allow a user to add and to visualize annotations 78 on a document. These annotations 78 could have been generated by this user or some other one on another representation of the document. This representation can, for example, itself have been generated from another data processing device 20.

More particularly, annotation application 22 is suitable for returning an annotation added to a representation 80 (namely to the return of the document generated by return management module 60 from the DOM representation of the document with which return management module 60 interacts) referred to as “source” of a document on a representation 82 referred to as “target” of the same document. Two representations of the same document can vary considerably form one another because of differences between the means of visualization used, the sizes of the visualization windows, the sizes of the fonts used, the levels of the zoom used etc.

Application 22 is also suitable for communication with dedicated server 18 via means 36 of communication of computer 12 to obtain information which it needs to be able to function, as will be seen in the following.

Application 22 comprises a functionality for creating annotation 78 on a representation of a document and a functionality for returning an annotation associated with a document.

The functionality of creating annotation 78 allows a user to create a personalized annotation 78, for example an image, a block of text, free text etc. and to associate it with a graphic element that comprises the document.

To this effect, application 22 of annotation allows the user to select the type of annotation 78 that he wants to add, the content of the annotation, a “source” element of the representation with which the annotation is associated, the position of the annotation relative to this source element etc.

These functions are implemented by a link 84 of tools generated only by return management module 60 with which the user can interact. This link 84 of tools allows the user to select an element of association (for example a box of text, an image, a withdrawn drawing), to modify some of its attributes (for example the color or size) and then to position the element on the web page.

Application 22 makes use only of functions present in the return management module 60 by use of HTML, CSS and Javascript technologies. HTML and CSS are used to implement the visual aspect of the annotation application, and the Javascript is used to implement the communication with server 18 and the logic of the application, namely the manner in which application 22 reacts to the actions of the user.

Moreover, annotation application 22 is executed in the “context” of return management module 60 and interacts only with it to generate or return annotations 78 on the documents.

In data processing, the “context” of an application is defined as the total of minimum resources needed by the processor to interrupt the execution of the application and to continue the execution of the application at the point where it was interrupted.

As is known, these resources comprise registers referred to as “general” and registers referred to as “of state” which the processor of the central unit uses to execute the application, as well as the zone of the memory used by the application. An application that functions in the context of another one thus has access to all these functionalities and data without restriction.

Thus, annotation application 22 treats only data contained in the actual registers of module 60 and with the suitable functions of return module 60 without recourse to other data or functions of navigation application 56 outside module 60.

At first the user selects from among several types the type of annotation 78 that he wants to add. These types thus correspond to an image such as a hoe (“smiley”) or an arrow, a field of text, free text etc.

Depending on the type of annotation created, annotation application 22 defines an anchoring point 86 associated with annotation 78. For example, anchoring point 86 of an image is the center of the image except if this image represents an arrow in which case the defined anchoring point will be the point end of the arrow. Moreover, the anchoring point of a free text is defined as being the first point of the first line made by the user via the means of capture.

For each annotation, the coordinates (X, Y) of its anchoring point are determined relative to the upper left corner of the page.

Via the execution of the standard JavaScript DOM document elementFrom Point( ) routine, application 22 extracts the values of the parameters of element 88 referred to as “source” (namely of the node corresponding to the DOM representation from which the source representation 80 is generated) of the source representation 80 which contains the coordinates (X, Y) to which annotation 78 is then associated.

These parameters—which among others contain the offset of coordinates between the anchoring point 86 of annotation 78 and element 88—present distinct degrees of importance.

The parameters referred to as essential contain the element type (image, text etc.).

The parameters referred to as being of high importance contain an ID or identification information, information about the source of source element 88—for example its URL—and the HTML textual content of the element—for example, when source element 88 is a paragraph.

The parameters of slight importance contain the coordinates of the source element 88 relative to the upper left corner of the page.

The values of these parameters are stored as is the information concerning the identification of the document to which the annotation is attached. All this information defines the annotation information 24.

This information concerning annotation 24 generated by application 22 during the creation of annotation 78 is then communicated to dedicated server 18 which stores it.

These data 24 are then required by annotation application 22 for the restitution of annotations 78 associated with a document visualized on a device 12 according to the invention.

To this effect, the application executes the Javascript DOM document.getElementsByTagName( ) routine from the value of the type of the source element which returns a table of candidate elements 90 having for their type the type of source element 88 to which annotation 78 is associated. This table is then stored in the memory.

From this table, a subtable of candidate elements 90 is generated by application 22 from candidate elements 90 of which at least one of the values of the parameters of high importance is equal to that of the corresponding parameter of source element 88.

In practice, the comparison of the properties of the elements is carried out from a condensate (“hash”) of properties. For reasons concerning the cost of the calculation, this condensate contains only a part of the values of these properties, for example the 32 initial or final characters thereof.

If a single candidate element 90 corresponds, it is selected as the target element 92 of the corresponding annotation.

If more than two elements correspond, the coordinates of candidate elements 90 are compared. The one whose coordinates in target representation 82 are closest to the coordinates of source element 88 in source representation 80 is selected.

If no element corresponds, the preceding comparison is repeated starting from the table of all candidate elements 90.

If annotation application 22 does not always identify target element 92, the coordinates of anchoring point 78 in source representation 80 are used to reposition annotation 78 on target representation 82.

In practice, once a target element 92 is identified, annotation application 22 obtains its coordinates and positions annotation 78 relative to this target element 92 by making this relative position correspond with annotation position 78 relative to source element 88.

Application 22 then modifies the DOM representation generated by return management module 60 which then brings about the anchoring of annotation 78 directly on representation 82 of the document it generates on visualization means 34.

Application 22 thus proceeds by anchoring a newly created annotation 78 to an element of the document considered.

In device 12 of the invention, annotation application 22 does not need to be installed before its use.

When the user of annotation application 22 wants to add an annotation 78 to a document, he implements application 22 via a scripted page marker 78 of its navigation application 56. Application 22 is then teleloaded by dedicated server 18 on the data processing device 12 and then injected into the document.

In one embodiment, the scripted page marker 74 is generated automatically by dedicated server 18 when the user registers to be able to use application 22. Scripted page marker 74 is inserted into a web page presented to the user by server 18 as a URL having an attribute text or image inviting the user to memorize this URL as page marker.

Such a process of deployment of application 22 on an electronic device is suitable for all devices the navigation application or applications of which have a return management module.

Because of the standard technologies—HTML, CSS, Javascript etc.—which application 22 exploits to function and because of the fact that it is injected into the web document, it does not require any modification of navigation application 56 to function and is based on no proprietary technology of a given navigation application 56 as is the case for a “plug-in”.

Hence, annotation application 22 is suitable to allow a user to add and visualize annotations to documents via all navigation applications, particularly navigation applications implemented on portable telephones.

Otherwise, the storing of application 22 on the dedicated server facilitates its revision, for example during a modification of the annotation process it is implementing.

In effect, only the revision of application 22 present on dedicated server 18 is then necessary.

The process of the invention will now be described in detail by reference to FIG. 4.

From a stage 210, the user acquires by navigation link 68 and using keyboard 32 the URL address of a Web document which he wants to consult. Navigation application 56 orders the treatment unit 38 to execute application 54 of the request. Request application 54 generates a request issued via communication means 36 to the destination of Web server 16 on which the document is stored.

At the end of this stage 210, web server 16 receives the request issued by data processing device 12.

During a stage 220, Web server 16 returns the content of the document.

At the end of this stage 220, data processing device 12 receives the contents of the document by its communication means 36. The document is then transmitted to return management module 60 of navigation application 56.

During a stage 230, return management module 60 constructs a DOM representation of the document and anchors representation 82 on screen 44.

During a stage 240, the user interacts with the navigator's page-marking system 72. The navigator actuates the scripted page marker 74.

During a stage 250, the request associated with scripted page marker 74 is sent by request-sending application 54 via communication means 36 to the dedicated server 18 destination.

At the end of this stage 250, dedicated server 18 receives the request destined to it.

In the course of a stage 260, server 18 dedicated to application 22 displays annotation application 22 on the data processing device 12.

At the end of this stage 260, the received application 22 is installed in the zone of memory 57 assigned to it and becomes capable of being executed.

During a stage 270, annotation application 22 orders the execution of request-forwarding application 54 by central unit 38. Data processing device 12 then sends a new request to the destination of dedicated server 18 via its communication means 36.

At the end of this stage 270, dedicated server 18 receives the request.

During a stage 280, dedicated server 18 transmits to data processing device 12 the annotation information 24 associated with the document.

During a stage 290, central unit 38 treats the information 24 received, and annotation application 22 determines if the annotations 78 associated with the document are returned to the representation 82 of the document.

During a stage 300, annotation application 22 identifies each of the target elements 92 of target representation 82 with which annotations 78 are associated as described in the following. This identification is carried out by the bias of standard JavaScript functions such as document.elementFromPoint( ) and by the standard attributes of HTML elements such as HTML.ElementObject.tagName,HTMLElementObject.innerHTML,HTMLElementObject.id.imageObject.src where HTMLElementObject represents a target element and imageObject represents a target element that is an image.

During a stage 310, annotation application 22 returns the annotations 78 via return management module 60 of navigation application 56 on target representation generated by module 60 from the DOM representation. This return is carried out by the bias of standard JavaScript functions such as document.getElementsByTagName( ) and by the standard attributes of HTML elements such as HTMLObject.innerHTML, HTMLElementObject.id, image-Object.src where HTMLElementObject represents a target element and imageObject a target element that is an image.

During a stage 320, the user proceeds or does not proceed to the creation of an annotation 78. If he does, the user will define via application 22 the annotation or annotations 78 that he adds to target representation 82 of the document as described in the following. The information of annotation 24 generated by creating one or more annotations 78 is stored in memory 52.

At the end of stage 320, annotations 78 are anchored to target representation 82 generated by return management module 60.

During a stage 330, annotation application 22 transmits to the destination of dedicated server 18 via communication means 36 the annotation information 24 generated in the course of stage 320. Dedicated server 18 then stores it in its storage means for further transmission to the destination of a data processing device 12 or 20 according to the invention from which the user wants to consult the annotations 78 added to the document.

1. Electronic device (12) of the type containing
a treatment unit (18),
anchoring means (34),
a navigation application (56) which comprises:
a graphic interface management module (58) with access to a network (14),
a return management module (60) of the document defining a context of execution of document return management module (60) which context contains the source data and treated data of the document return management module (60)
a suitable annotation application (22) for restoring and/or adding annotations (78) on a document treated by the navigation application (56) in order to anchor an annotated representation of the document (80, 82),
characterized in that it comprises means of injection into the document of said annotation application (22) in order to extend the document, and the annotation application (22) is suitable to be executed from the extended document only in the context of execution of the return management module (60) of the document on the source data and treated data of the document management module (60), and by use of the same functions as used by the return management module (60) of the document and in that the document treated by the navigation application (56) comprises graphic elements, the annotation application (22) being suitable for anchoring an annotation (78) at a point of a graphic element of the document independently of the coordinates of the graphic element in the document.

2. Electronic device (12) according to claim 1, characterized in that it comprises means of teleloading from a dedicated server of the application (22).

3. Electronic device (12) according to claim 1 or 2, characterized in that the navigation application (56) comprises means of release of the injection of the annotation application (22) on the electronic device (12).

4. Electronic device (12) according to claim 3, characterized in that the navigation application (56) comprises means for the creation of personalized scripted page markers (74), the means of injection of the annotation application (22) comprising the actuation of a scripted page marker (74).

5. Electronic device (12) according to any one of the preceding claims, characterized in that the document is an HTML file.

6. Electronic device (12) according to any one of the preceding claims, characterized in that the return management module (60) of the navigation application or navigation applications comprises means for generating the representation (80, 82) of the document annotated from the DOM representations of the document.
